(19) United States
(12) Patent Application Publication
(10) Pub. No.: US 2003/0145201 A1
(43) Pub. Date: Jul. 31, 2003

(54) On line security method

(76) Inventor: Hubert Juillet, Willer sur Thur (FR)

Correspondence Address: JACOBSON HOLMAN PLLC, 400 SEVENTH STREET N.W., SUITE 600, WASHINGTON, DC, 20004, US

(21) Appl. No.: 10/323,598

(22) Filed: Dec. 19, 2002

Related U.S. Application Data
(63) Continuation-in-part of application No. PCT/FR01/01916, filed on Jun. 19, 2001.

(30) Foreign Application Priority Data
Jun. 20, 2000 (FR) 00 07840
Jan. 23, 2001 (FR) 01 00967

(51) Int. Cl. H04L 9/00; G06F 17/60

(52) U.S. Cl. 713/168; 705/64; 705/75

(57) ABSTRACT

This invention relates to a secure online authentication and/or order and/or purchase and/or payment method. To operate, said method does not require any specific configuration of the internaut's computer or the Web page of trader sites or other sites. It simply consists in inserting a storage medium into the computer. The storage medium comprises an original executable programme which sends the Web page present on the computer screen and an ephemeral number to the issuer of said medium for authentication. After authentication by the issuer, the latter sends an order to the trader site in accordance with the specifications of said input Web page. The invention is applicable to electronic commerce.

The present invention relates, by way of novel industrial product, to a method for online authentication, and/or payment, and/or order, and/or purchase on a network such as Internet.

Solutions for authentication are already known, employing one-use signs, called “ephemeral numbers” which are edited in duplicate by an issuer; the latter keeps one of said duplicates, and delivers the other of said duplicates to an entity which is a previously identified internaut listed with it. Said duplicate is recorded on a data medium.

During a payment online, said entity manually transmits one of said ephemeral numbers online to a trader site and this transmission is then authenticated by the comparison of said ephemeral number with its duplicate by said issuer to whom said number was retransmitted by said trader site, and thus constitutes an authentication and/or a payment online.

These systems present the drawback of requiring a complex installation thereof.

It is an object of the present invention to overcome these drawbacks by proposing a method which allows the following novel technical effects to be obtained:

producing an online authentication, and/or payment, and/or order, and/or purchase on a network such as Internet, by the simple act of introducing a data medium into a computer,

effecting such execution from any computer connected to a network, without said internaut customer having to adapt this computer, configure it or record anything whatsoever, before, during and after such execution,

effecting such execution when a Web page representing a product and/or a desired service is displayed on the screen,

effecting such execution on any Web page, without the latter needing to be configured for the use of the present method,

effecting such execution on any Web site without the latter needing to have a payment terminal and/or an authentication system available, or needing to be configured for the use of the present method,

effecting such execution on any Web site, without the latter needing to have available a specific service provider, for effecting a sale and/or collection of payment online, in accordance with the present method,

effecting such execution on any Web site, without the latter needing to be informed of the existence of the present method.

To that end, the present invention allows the afore-mentioned novel technical effects to be obtained by recording on said data medium, in addition to said duplicate of ephemeral numbers, a software and/or an executable programme comprising data-processing steps allowing:

the online capture of the Web page which is displayed on the screen of said computer,

the online dispatch of said captured Web page,

the online dispatch of various data and information,

the online dispatch of one of said ephemeral numbers taken from said medium and, at every new dispatch, a fresh said number likewise taken each time from said medium.

Said software is executable from said medium and is automatically executed after its introduction into said computer.

Said dispatches are effected by electronic mail, and/or by webmail, or directly on a server or by any means other than by Internet, online or offline.

The address of the recipient of said dispatch or dispatches is that of said issuer.

After reception of said dispatch, said issuer compares said ephemeral number marked thereon with the list of those that it has in duplicate, and validates or invalidates said reception depending on whether or not said number is recognized.

After validation, as the case may be, said issuer transmits a copy of said dispatch, authenticated and accompanied, or not, by a means of payment, to the site concerned by said Web page. This dispatch constitutes an order.

The present invention is not limited to the forms of embodiment described hereinabove, which constitute only one example of applications, to which numerous modifications may be made without departing from its field of application. For example:

Said method may also comprise a data-processing step whereby said internaut's computer disconnects itself from said site of said Web page after said capture.

One or more data files are recorded on said data medium.

In order to be launched, said executable software may require a click.

The issuer of said data medium may be a third person of confidence.

Said programme comprises empty memory boxes.

At least certain of said empty memory boxes are filled by said internaut customer.

At least certain of said empty memory boxes are filled by downloadings.

Said programme and/or software further comprises at least one access code.

A credit is allocated to said data medium, which thus allows it to serve as electronic purse.

Said captured Web page is any zone whatsoever.

A price or sales conditions are mentioned on said captured Web page.

All types of links or elements that may or may not be picked up by said capture or activated by said executable software or the like may be placed on said captured Web page.

Said data medium may be used on any computer whatsoever, including that of a trader, in order to effect a direct purchase in its store or space.

Said data medium may be a bank card, a smart card, a diskette or a CD-Rom.

Said data medium may be used on any computer whatsoever equipped with adequate drive and/or burner.

The present method may also be used for effecting selective online purchases.

For example, like the advertizing zones of Internet, it is possible to propose zones showing a product or products for sale. In that case, when such a zone appears, it suffices to introduce said data medium into one's computer, then this medium attends to purchasing and automatically paying for said product.

The address of said dispatch(es) is that of said issuer, or that of any other recipient.

Said file(s) on said medium may be called up or opened by all types of links; the latter may be placed on the internaut's computer screen, on the Web page of a trader site, or of another site, or via electronic mail.

Finally, numerous softwares and programmes may be used for executing the present data-processing steps without departing from the field of application of the present invention.

Said issuer may perform of the role of a third person of confidence.

The present invention comprises numerous advantages over the present state of the art concerning online authentication and payment. For example:

Trader sites must, at the present time, install software for interactivity on their servers, with forms to be filled in by the internauts so that the latter can identify themselves, designate the desired products, communicate their means of payment.

The trader sites obtain such software from service providers, particularly those which make use of bank cards or smart cards.

The Web pages of these sites must be arranged specifically to allow such use and numerous constraints are demanded in this respect.

The payment systems in question are very dependent on their service providers and solid agreements bind the parties.

With the present invention, these different constraints do not exist. For example:

When an internaut is surfing on Internet and visits a Web page of a trader site on which a product for sale is displayed, said internaut and said trader site do not know each other a priori.

If said internaut wishes to purchase said displayed product, he/she has the choice of following the purchasing instructions of said trader site or of opting to use the present method.

If said internaut opts for the latter solution, he then simply introduces said data medium into his computer and will have nothing else to do. The purchase and/or payment will be automatically effected by the executable software of said medium and in accordance with said data-processing steps, whatever the configuration of said trader site.

Information is then sent to said issuer online, in accordance with said data-processing steps, which issuer processes it as soon as it is received.

The trader site will shortly receive from said issuer an electronic mail or the like which will include an order which takes up said page, accompanied or not by an accreditive letter or another means of payment.

The trader site then has the choice of accepting or of refusing said order, but it will not have to take any prior step with said issuer and/or internaut to that end.

Moreover, if a trader site wishes to limit itself to the use of the present method, it no longer has need of software, of service provider, or of anything in order to effect a sale and/or receive payment online.

In that case, the trader site is reduced to its simplest terms, namely presenting simple Web pages on the Internet, with the products for sale and their price.

From the standpoint of security, as the ephemeral numbers are never recorded in a memory of the internaut's computer, an intrusion into said computer by a computer cracker is without consequence on the confidential nature of said numbers.

1. Method for online authentication, and/or payment, and/or order, and/or purchase on a network such as Internet, employing one-use signs, called “ephemeral numbers” which are edited in duplicate by an issuer; the latter keeps one of said duplicates, and delivers the other of said duplicates to an entity which is a previously identified internaut listed with it; said duplicate is recorded on a data medium; said entity manually transmits one of said ephemeral numbers online and this transmission is then authenticated by the comparison of said ephemeral number with its duplicate and thus constitutes an authentication and/or a payment online,
wherein said method makes it possible to obtain the following novel technical effects of:
producing an online authentication, and/or payment, and/or order, and/or purchase on a network such as Internet, by the simple act of introducing a data medium into a computer,
effecting such execution from any computer connected to a network, without said internaut customer having to adapt this computer, configure it or record anything whatsoever, before, during and after such execution,
effecting such execution when a Web page representing a product and/or a desired service is displayed on the screen,
effecting such execution on any Web page, without the latter needing to be configured for the use of the present method,
effecting such execution on any Web site without the latter needing to have a payment terminal and/or an authentication system available, or needing to be configured for the use of the present method or even to be informed of its existence,
effecting such execution on any Web site, without the latter needing to have available a specific service provider other than said issuer to effect a sale, and/or a service and/or collection of payment online, in accordance with the present method, said novel technical effects are obtained by the combined recording on said data medium, of said duplicate of ephemeral numbers and of an executable software comprising data-processing steps allowing:
the online capture of the Web page which is displayed on the screen of said computer,
the online dispatch of said captured Web page,
the online dispatch of various data and information,
the online dispatch of one of said ephemeral numbers taken from said medium and, at every new dispatch, a fresh said number likewise taken each time from said medium;
said software is executable from said medium and is automatically executed after its introduction into said computer; and
said dispatches are effected by electronic mail, and/or by webmail, or directly on a server or by any means other than by Internet, online or offline; and
the address of the recipient of said dispatch(es) is that of said issuer.

2. The method of claim 1, wherein it further comprises a data-processing step whereby the said internaut's computer disconnects itself from said site of said Web page after said capture.

3. The method of claim 1, wherein one or more data files are recorded on said data medium.

4. The method of claim 1, wherein said data medium is a CD-Rom, a disquette, or a smart card.

5. The method of claim 1, wherein, after reception of said dispatch, said issuer compares said ephemeral number mentioned thereon with the list of those that it has in duplicate, then it validates or invalidates said reception depending on whether or not said number is recognized, and then transmits said authenticated Web page online.

6. The method of claim 1, wherein the recipient of said transmission is the site concerned by said Web page.

7. The method of claim 1, wherein said issuer attaches a means of payment to said transmission.

8. The method of claim 1, characterized by a computer-produced programme comprising programme code instructions recorded on a medium usable in a computer, comprising computer-readable programmation means, able to carry out the steps of claim 1.
